(19) United States
(12) Patent Application Publication
(10) Pub. No.: US 2011/0100549 A1
(43) Pub. Date: May 5, 2011

(54) METHOD FOR MANUFACTURING COMPONENT-EMBEDDED MODULE

(75) Inventor: Shunsuke CHISAKA, Nagaokakyo-shi (JP)

(73) Assignee: MURATA MANUFACTURING CO., LTD., Nagaokakyo-shi (JP)

(21) Appl. No.: 13/006,467

(22) Filed: Jan. 14, 2011

Related U.S. Application Data
(63) Continuation of application No. PCT/JP2009/001942, filed on Apr. 29, 2009.

(30) Foreign Application Priority Data
Jul. 17, 2008 (JP) 2008-186392

(51) Int. Cl. B32B 37/02; B32B 37/06; B32B 37/10

(52) U.S. Cl. 156/308.2

(57) ABSTRACT

A method for manufacturing a component-embedded module includes a first step of preparing a first resin layer made of a thermoplastic resin and including wiring patterns on one of primary surfaces of the first resin layer, a second resin layer made of a thermoplastic resin, and a circuit component including terminal electrodes, and a second step of stacking, heating, and press-bonding the first and second resin layers in a state in which the circuit component is arranged between the one primary surface of the first resin layer and the second resin layer. In the second step, the wiring patterns on the one primary surface of the first resin layer and the terminal electrodes of the circuit component are bonded to each other by solid phase diffusion bonding, to connect the wiring patterns on the one primary surface of the first resin layer and the terminal electrodes of the circuit component to each other.

### BACKGROUND OF THE INVENTION

1. Field of the Invention

The present invention relates to a method for manufacturing a component-embedded module, and more particularly, to a method for manufacturing a component-embedded module including a circuit component that is embedded in a substrate body that is made of a thermoplastic resin.

2. Description of the Related Art

Conventionally, various methods have been disclosed for manufacturing a component-embedded module including a circuit component that is embedded in a resin substrate.

For example, as shown in a cross-sectional view in FIG. 4A, circuit components 141 are inserted into recesses 182 of a sheet member 181 that is made of a thermoplastic resin, and the circuit components 141, single-sided conductive pattern films 121, and a heat sink 146 are stacked on each other. Each of the single-side conductive pattern films 121 includes conductive patterns 122 on only one surface of a resin film 123 made of a thermoplastic resin. Via holes (through holes) 124 are provided in the resin film 123 and filled with conductive paste 150 such that the conductive paste 150 contacts the conductive patterns 122.

After stacking, as shown in a cross-sectional view in FIG. 4B, the stack is pressed from both sides while applying heat, and consequently, a component-embedded module 100 is produced. At this time, terminal electrodes 142 of each of the circuit components 141 are electrically connected to a corresponding conductive pattern 122 via a connection conductor 151 made of the conductive paste 150. Further, the resin films 123 and the sheet member 181 are plastically deformed while the resin films 123 and the sheet member 181 are thermally adhered to each other, and consequently, form an insulating substrate 139 that encapsulates the circuit components 141 (see, for example, Japanese Unexamined Patent Application Publication No. 2003-17859).

However, with this method, the conductive paste 150 may flow into an area between the terminal electrodes 142 of each of the circuit components 141 as a result of a pressure applied during stacking. Further, if the inner diameter of each of the via holes 124 is decreased or the distance between the via holes 124 is decreased, it may be difficult to form the via holes 124.

Thus, for example, if the distance between the terminal electrodes 142 of each of the circuit components 141 is small or if the distance between the circuit components 141 is small, it may be difficult to manufacture the component-embedded module 100, and each of the circuit components 141 cannot be reduced in size or have a fine structure.

### SUMMARY OF THE INVENTION

To overcome the problems described above, preferred embodiments of the present invention provide a method for manufacturing a component-embedded module which enables a circuit component to be reduced in size and to have a fine structure.

A method for manufacturing a component-embedded module according to a preferred embodiment of the present invention preferably includes a first step of preparing a first resin layer made of a thermoplastic resin and including a wiring pattern on one primary surface of the first resin layer, a second resin layer made of a thermoplastic resin, and a circuit component including a terminal electrode, and a second step of stacking, heating, and press-bonding the first and second resin layers in a state in which the circuit component is arranged between the one primary surface of the first resin layer and the second resin layer. In the second step, preferably, the first and second resin layers are press-bonded to each other, and simultaneously, the wiring pattern on the one primary surface of the first resin layer and the terminal electrode of the circuit component are bonded to each other by solid phase diffusion bonding, so as to connect the wiring pattern on the one primary surface of the first resin layer and the terminal electrode of the circuit component to each other.

Since the wiring pattern on the one primary surface of the first resin layer and the terminal electrode of the circuit component are bonded to each other preferably by solid phase diffusion bonding in the second step, the wiring pattern or the terminal electrode of the circuit component is not melted and does not flow into other regions. Further, since the periphery of the bonded wiring pattern and terminal electrode is preferably surrounded by the resin layers that are softened by heating, a melted portion does not connect adjacent wiring patterns to each other and, thus, does not cause a short circuit therebetween. Accordingly, even if the distance between terminal electrodes of the circuit component that is arranged in the component-embedded module is decreased or the distance between circuit components is decreased, the occurrence of a short circuit can be effectively prevented.

Preferably, in the second step, the first and second resin layers are stacked such that a position of the circuit component is fixed with respect to the wiring pattern on the one primary surface of the first resin layer.

In this case, when the first and second resin layers are stacked in the second step, the circuit component is prevented from moving relative to the wiring pattern on the one primary surface of the first resin layer.

Preferably, in the second step, the first and second resin layers are stacked such that the position of the circuit component is fixed with respect to the wiring pattern on the one primary surface of the first resin layer using a temporary fixing member, and the fixing member disappears after the first and second resin layers are stacked and before the stack is heated and press-bonded.

In this case, since the first and second resin layers are heated and press-bonded after the temporary fixing member disappears, the temporary fixing member does not remain in the component-embedded module. Accordingly, the temporary fixing member is not disposed between the resin layers and, thus, does not cause adverse effects, such as cracking.

Preferably, the temporary fixing member is an organic solvent, for example.

The organic solvent is easily vaporized and disappears, and thus, the method can be easily performed.

Preferably, the second resin layer includes a through hole or a recess. In the second step, the first and second resin layers are stacked, heated, and press-bonded such that the circuit component is arranged in the through hole or the recess of the resin layer.

In this case, the thickness of the second resin layer can be reduced. The height of the component-embedded module can be reduced and the density can be effectively increased.

Preferably, the wiring pattern on the one primary surface of the first resin layer is formed by processing a metallic foil that is arranged on the one primary surface of the first resin layer.

In this case, the wiring pattern can be easily formed using the metallic foil.

Preferably, a surface of the wiring pattern on the one primary surface of the first resin layer is covered with a metal that is different from a metal provided on a surface of the terminal electrode of the circuit component.

In this case, the terminal electrode of the circuit component and the wiring pattern on the one primary surface of the first resin layer are connected to each other by an alloy that is formed when the metal on the surface of the wiring pattern on the one primary surface of the first resin layer and the metal on the surface of the terminal electrode of the circuit component are bonded to each other by solid phase diffusion bonding in the second step.

Preferably, a surface of the wiring pattern on the one primary surface of the first resin layer is covered with the same metal as a metal provided on a surface of the terminal electrode of the circuit component.

In this case, the metal on the surface of the wiring pattern on the one primary surface of the first resin layer and the metal on the surface of the terminal electrode of the circuit component are bonded to each other by solid phase diffusion bonding in the second step, and the terminal electrode of the circuit component and the wiring pattern on the one primary surface of the first resin layer are connected to each other by the metal.

Preferably, the metal that covers the surface of the terminal electrode of the circuit component and the metal provided on the surface of the wiring pattern on the one primary surface of the first resin layer are gold, for example.

In this case, since the terminal electrode of the circuit component and the wiring pattern on the one primary surface of the first resin layer are connected to each other via the gold by solid phase diffusion bonding in the second step and the gold does not form an oxide film, this connection is highly reliable.

Preferably, the thermoplastic resin is liquid crystal polymer, for example.

Since the liquid crystal polymer absorbs less water as compared to other thermoplastic resins, even if the wiring pattern is formed by etching on the one primary surface of the first resin layer, the liquid crystal polymer is deformed very slightly. Thus, the liquid crystal polymer is particularly preferable.

With various preferred embodiments of the present invention, the circuit component can be reduced in size and have a fine structure.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A to 1D are cross-sectional views showing a manufacturing process of a component-embedded module according to a preferred embodiment of the present invention.

FIGS. 2A and 2B are cross-sectional views showing the manufacturing process of the component-embedded module according to a preferred embodiment of the present invention.

FIGS. 3A and 3B are cross-sectional views showing the manufacturing process of the component-embedded module according to a preferred embodiment of the present invention.

FIGS. 4A and 4B are cross-sectional views showing a known manufacturing process of a component-embedded module.

### DETAILED DESCRIPTION OF THE PREFERRED EMBODIMENTS

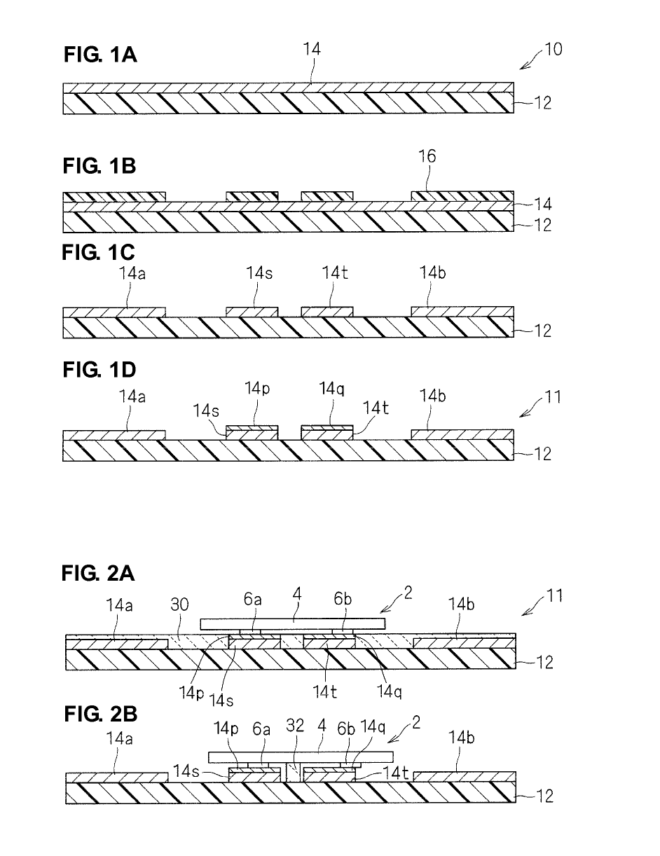

Preferred embodiments of the present invention will be described below with reference to FIGS. 1A to 3B. FIGS. 1A to 3B provide cross-sectional views showing a manufacturing process of a component-embedded module 50.

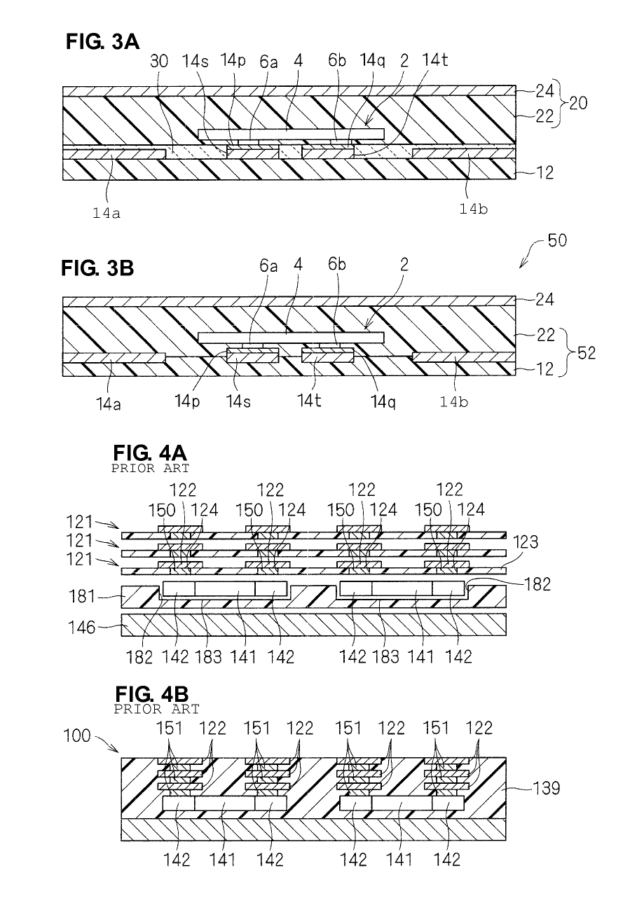

Referring to FIG. 3B, the component-embedded module 50 preferably includes wiring patterns 14a, 14b, 14s, and 14t provided in a substrate body 52 in which resin layers 12 and 22 made of a thermoplastic resin are bonded to each other, and terminal electrodes 6a and 6b of a chip component 2, such as an IC chip or a capacitor, for example, fixed to the wiring patterns 14s and 14t. Specifically, thin metal films 14p and 14q that cover the wiring patterns 14s and 14t are preferably connected to a metal on the surfaces of the terminal electrodes 6a and 6b of the circuit component 2 by solid phase diffusion bonding. A body 4 of the circuit component 2 is preferably embedded in the thermoplastic resin of the substrate body 52.

Next, a method for manufacturing the component-embedded module 50 will be described.

First, a resin substrate 11 shown in FIG. 1D is manufactured.

In particular, referring to FIG. 1A, preferably, a resin sheet 10 is prepared, the resin sheet 10 preferably including a resin layer 12 made of a thermoplastic resin and a metallic foil 14 provided on one surface of the resin layer 12, a photosensitive resist is applied on the metallic foil 14, and exposure and development are performed so as to form a mask pattern 16 as shown in FIG. 1B. Etching is performed on the metallic foil 14 through the mask pattern 16, and then the mask pattern 16 is removed to form wiring patterns 14a, 14b, 14s, and 14t on the resin layer 12 as shown in FIG. 1C. Then, sputtering or plating, for example, is performed to form thin films 14p and 14q that cover the wiring patterns 14s and 14t as shown in FIG. 1D.

Next, referring to FIGS. 2A and 2B, a circuit component 2 is mounted on the resin substrate 11.

In particular, preferably, a temporary fixing member 30 is applied on the entire upper surface of the resin substrate and then the circuit component 2 is mounted on the wiring patterns 14s and 14t of the resin substrate 11 as shown in FIG. 2A. At this time, the temporary fixing member 30 is provided between terminal electrodes 6a and 6b of the circuit component 2 and the thin films 14p and 14q that cover the wiring patterns 14s and 14t of the resin substrate 11, and the temporary fixing member 30 bonds the terminal electrodes 6a and 6b to the thin films 14p and 14q. Alternatively, the temporary fixing member 30 may preferably be partially applied to a region in which the circuit component 2 is arranged and a peripheral region thereof.

Still alternatively, a temporary fixing member 32 may preferably be applied to at least one of a portion of the circuit component 2 excluding the terminal electrodes 6a and 6b and a portion of the resin substrate 11 excluding the wiring patterns 14s and 14t, and the circuit component 2 may be mounted on the wiring patterns 14s and 14t of the resin substrate 11 as shown in FIG. 2B. In this case, the temporary fixing member 32 is provided between the body 4 of the circuit component 2 and the resin layer 12 of the resin substrate 11, and the temporary fixing member 32 bonds the body 4 to the resin layer 12. Thus, the temporary fixing member 32 maintains an arrangement in which the terminal electrodes 6a and 6b of the circuit component 2 are in contact with the thin films 14p and 14q that cover the wiring patterns 14s and 14t of the resin substrate 11.

Next, referring to FIGS. 3A and 3B, the resin sheet 20 is preferably stacked on the resin substrate 11 with the circuit component 2 mounted thereon, and the stack is heated and press-bonded.

In particular, preferably, the resin sheet 20 including a metallic foil 24 on one surface of the thermoplastic resin layer 22 is stacked on the resin substrate 11 on which the circuit component 2 is bonded by the temporary fixing member 30 (or 32) such that the resin layer 22 faces the circuit component and the resin substrate 11 as shown in FIG. 3A. Since the circuit component 2 is fixed by the temporary fixing member 30 (or 32) during stacking, the position of the circuit component 2 is prevented from being shifted relative to the wiring patterns 14s and 14t when the resin sheet 20 is stacked.

After stacking, by heating the stack preferably in a vacuum, the component-embedded module 50 is completed as shown in FIG. 3B. In particular, by heating the stack, the resin layers 12 and 22 are softened, press-bonded to each other, and thus, integrated with each other. In addition, the metal on the surface of the terminal electrodes 6a and 6b of the circuit component 2 is bonded to the metal thin films 14p and 14q that cover the wiring patterns 14s and 14t of the resin substrate 11 in a region near the interfaces of the metals by solid phase diffusion bonding through heating. Accordingly, the terminal electrodes 6a and 6b of the circuit component 2 are connected to the wiring patterns 14s and 14t without printing a solder on the wiring patterns 14s and 14t. In particular, at least a portion of the thin films 14p and 14q (or wiring patterns) may preferably be melted when the resin sheet is heated and press-bonded, so that the thin films 14p and 14q are electrically connected to the terminal electrodes 6a and 6b by solid phase diffusion.

If the metal on the surface of the terminal electrodes 6a and 6b of the circuit component 2 and the metal thin films 14p and 14q that cover the wiring patterns 14s and 14t of the resin substrate 11 are bonded to each other in the region near the interfaces of the metals by solid phase diffusion bonding, the metal of the terminal electrodes 6a and 6b or the thin films 14p and 14q is not melted and, thus, does not flow to other regions. Further, since the peripheries of the bonded wiring patterns 14s and 14t and terminal electrodes 6a and 6b are surrounded by the resin layers 12 and 22 that are softened by heating, the melted portion does not connect the adjacent wiring patterns 14s and 14t to each other and, thus, does not cause a short circuit therebetween. Accordingly, even if the distance between the terminal electrodes 6a and 6b of the circuit component 2 is decreased, or a plurality of circuit components are arranged in the component-embedded module at small intervals, a short is effectively prevented from occurring. Further, since the wiring patterns 14s and 14t are metallic foils, the wiring patterns 14s and 14t are more stable than a conductor made of conductive paste that is an aggregate of metal powder. Thus, an alloy is unlikely to be formed, and a phenomenon called “leaching” does not occur. Accordingly, a solid phase diffusion amount between the metal of the wiring patterns and the metal of the thin films can be easily controlled.

After heating and press-bonding, the component-embedded module 50 is completed as shown in FIG. 3B. Preferably, the metallic foil 24 that is exposed to the surface of the component-embedded module 50 may be used for a magnetic shield. Alternatively, the metallic foil 24 may preferably define a surface mounting electrode, and a surface-mount electronic component may be mounted on the upper surface of the component-embedded module 50. In this case, the resin sheet 20 including the wiring pattern made of the metallic foil 24 may preferably be stacked on the resin substrate 11, and the stack may be heated and press-bonded. Alternatively, the resin sheet 20 may preferably be stacked on the resin substrate 11 and the stack may be heated and press-bonded. Then, the metallic foil 24 may be processed by, for example, etching so as to form the surface mounting electrode.

The component-embedded module 50 will be described below in further detail.

A material that is easily processed and is not significantly deformed after processing is preferable for the resin sheets 10 and 20. For example, a thermoplastic resin, such as liquid crystal polymer (LCP), polyimide, or fluorocarbon resin, may preferably be used. In particular, the liquid crystal polymer absorbs very little water and is only very slightly deformed after etching. Thus, the liquid crystal polymer is particularly preferable. A material that can easily be formed into a predetermined shape, for example, copper is preferably used for the metallic foils 14 and 24 on the resin sheet.

Preferably, a through hole or a recess may be provided in the resin sheet 20 by laser processing or punching with a die, for example, the resin sheet 20 may be stacked on the resin substrate 11 while the circuit component 2 is arranged in the through hole or recess, and then the stack may be heated and press-bonded. In this case, the thickness of the resin sheet 20 can be reduced. Consequently, the height of the component-embedded module 50 can be reduced and the density thereof can be increased.

The thin films 14p and 14q that cover the wiring patterns 14s and 14t are preferably Sn or Au, for example, if the terminal electrodes 6a and 6b of the circuit component 2 (for example, bumps of an IC chip) is Au.

If the metal of the thin films 14p and 14q that cover the wiring patterns 14s and 14t is Sn, Au that is the metal on the surface of the terminal electrodes 6a and 6b of the circuit component 2 and that is different from the metal of the thin films 14p and 14q is bonded to Sn of the thin films 14p and 14q in the region near the interfaces of the metals by solid phase diffusion bonding, and thus, a Au—Sn alloy is formed. Accordingly, the terminal electrodes 6a and 6b of the circuit component 2 are securely connected to the wiring patterns 14s and 14t.

If the metal of the thin films 14p and 14q that cover the wiring patterns 14s and 14t is Au, Au that is the metal on the surface of the terminal electrodes 6a and 6b of the circuit component 2 and that is the same metal as of the thin films 14p and 14q is bonded to Au of the thin films 14p and 14q by solid phase diffusion bonding. Accordingly, the terminal electrodes 6a and 6b of the circuit component 2 are securely fixed to the wiring patterns 14s and 14t. Since Au does not form an oxide film, Au provides a highly reliable connection.

Even if the wiring patterns 14s and 14t are not covered with the thin films 14p and 14q made of, for example, Sn or Au, the wiring patterns 14s and 14t may be directly bonded to the terminal electrodes 6a and 6b by solid phase diffusion bonding.

The temporary fixing member 30 or 32 that fixes the position of the circuit component 2 with respect to the wiring patterns 14s and 14t of the resin substrate 11 may preferably use a conventional epoxy or acrylic adhesive member, for example. However, if the adhesive member remains in the component-embedded module 50, the adhesive may produce an adverse effect, such as cracking.

Due to this adverse effect, the temporary fixing member 30 or 32 preferably disappears after the resin sheet 20 is stacked on the resin substrate 11 and before the respective resin sheets are integrated by being heated and press-bonded. In particular, heating and press-bonding of the stacked resin substrate 11 and resin sheet 20 are preferably performed after the temporary fixing member 30 or 32 disappears. After stacking, the state in which the resin sheet 20 is stacked on the circuit component 2 is maintained. Thus, even if the temporary fixing member 30 or 32 disappears, the position of the circuit component 2 is not shifted relative to the wiring patterns 14s and 14t. The temporary fixing member may be provided on the wiring pattern, or on the resin sheet. If the temporary fixing member is provided on the wiring pattern, the temporary fixing member preferably has a viscosity such that the temporary fixing member flows and causes the terminal electrodes of the circuit component to contact the wiring patterns when the circuit component is temporarily fixed to the resin sheet.

In this case, the temporary fixing member 30 or 32 can be reliably prevented from remaining in the component-embedded module 50. Accordingly, the temporary fixing member 30 or 32 does not produce any adverse effects, such as cracking.

The temporary fixing member 30 or 32 may preferably include, for example, an organic solvent that has a higher viscosity than water and that disappears at a lower temperature (for example, about 200° C.) than a heating temperature (for example, about 300° C.) in a heating and press-bonding step. The organic solvent may be, for example, ethylene glycol, glycerin, or oligomer, for example. Such an organic solvent is easily vaporized and disappears.

The temporary fixing member 30 or 32 may preferably include a liquid, such as an organic solvent having a relatively high viscosity when the circuit component 2 is bonded.

Alternatively, the temporary fixing member may preferably include an organic solvent having a viscosity that is relatively low during temporary bonding and that is increased (or the member is solidified) when the temperature is increased after temporary bonding, so as to fix the position of circuit component 2. In this case, the temporary fixing member 30 or 32 is applied and the circuit component 2 is arranged at a predetermined position on the resin substrate 11, and then the temperature is decreased to temporarily bond the circuit component 2 to the resin substrate 11. In this state, a subsequent stacking step is performed. For example, a temporary fixing member 30 or 32 having a freezing point of about 60° C. is preferably used. The temporary fixing member 30 or 32 in the form of liquid is applied to the resin substrate 11 at a temperature greater than (for example, about 80° C.) than room temperature. The circuit component 2 is mounted, and then the temperature is returned to the room temperature to solidify the temporary fixing member 30 or 32. In this solidified state, the circuit component 2 is temporarily fixed and the resin sheet 20 is stacked.

As described above, the resin layers 12 and 22 preferably are stacked, heated, and press-bonded, and the terminal electrodes 6a and 6b of the circuit component 2 are bonded to the wiring patterns 14s and 14t by solid phase diffusion bonding through heating and press-bonding. Accordingly, even if the distance between the terminal electrodes 6a and 6b of the circuit component 2 is very small or the distance between the plurality of circuit components arranged in the component-embedded module is very small, a short circuit is effectively prevented, and the component can be reduced in size and have a fine wiring pattern.

The present invention is not limited to the above-described preferred embodiments, and various modifications can be made.

For example, three or more resin layers may preferably be provided and stacked.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method for manufacturing a component-embedded module, the method comprising:
a first step of preparing a first resin layer made of at least a thermoplastic resin and including a wiring pattern on one primary surface of the first resin layer, a second resin layer made of at least a thermoplastic resin, and a circuit component including a terminal electrode; and
a second step of stacking, heating, and press-bonding the first and second resin layers in a state in which the circuit component is arranged between the one primary surface of the first resin layer and the second resin layer; wherein
in the second step, the first and second resin layers are press-bonded to each other, and simultaneously, the wiring pattern on the one primary surface of the first resin layer and the terminal electrode of the circuit component are bonded to each other by solid phase diffusion bonding to connect the wiring pattern on the one primary surface of the first resin layer and the terminal electrode of the circuit component to each other.

2. The method for manufacturing the component-embedded module according to claim 1, wherein in the second step, the first and second resin layers are stacked in a state in which a position of the circuit component is fixed with respect to the wiring pattern on the one primary surface of the first resin layer.

3. The method for manufacturing the component-embedded module according to claim 2, wherein in the second step, the first and second resin layers are stacked in a state in which the position of the circuit component is fixed with respect to the wiring pattern on the one primary surface of the first resin layer by a temporary fixing member, and the fixing member disappears after the first and second resin layers are stacked and before the stack is heated and press-bonded.

4. The method for manufacturing the component-embedded module according to claim 3, wherein the temporary fixing member is an organic solvent.

5. The method for manufacturing the component-embedded module according to claim 4, wherein
the second resin layer includes a resin layer including a through hole or a recess; and
in the second step, the first and second resin layers are stacked, heated, and press-bonded in a state in which the circuit component is arranged in the through hole or the recess of the resin layer of the second resin layer.

6. The method for manufacturing the component-embedded module according to claim 1, wherein the wiring pattern on the one primary surface of the first resin layer is formed by processing a metallic foil that is arranged on the one primary surface of the first resin layer.

7. The method for manufacturing the component-embedded module according to claim 6, wherein a surface of the wiring pattern on the one primary surface of the first resin layer is covered with a metal that is different from a metal on a surface of the terminal electrode of the circuit component.

8. The method for manufacturing the component-embedded module according to claim 6, wherein a surface of the wiring pattern on the one primary surface of the first resin layer is covered with the same metal as a metal on a surface of the terminal electrode of the circuit component.

9. The method for manufacturing the component-embedded module according to claim 8, wherein the metal that covers the surface of the terminal electrode of the circuit component is gold.

10. The method for manufacturing the component-embedded module according to claim 1, wherein the thermoplastic resin of at least one of the first resin layer and the second resin layer is liquid crystal polymer.
